(19) United States
(12) Patent Application Publication
(10) Pub. No.: US 2004/0006738 A1
(43) Pub. Date: Jan. 8, 2004

(54) Source of record manager

(76) Inventors: Pamela Szabo, Houston, TX (US); Daquer Reveron, Humble, TX (US)

Correspondence Address: Margaret A. Boulware, Jenkens & Gilchrist, A PROFESSIONAL CORPORATION, 1100 Louisiana, Suite. 1800, Houston, TX, 77002-5214, US

(21) Appl. No.: 10/188,503

(22) Filed: Jul. 2, 2002

(51) Int. Cl. G06F 15/00

(52) U.S. Cl. 715/513; 715/517

(57) ABSTRACT

Method and system are disclosed for identifying and managing sources of record. The sources of record may be any source of information or data that has been sanctioned or otherwise designated as an approved source. Each information source has or may have one or more source templates associated therewith that describe or point to the information source and the information or data therein. A reference template may then be defined that describes or points to certain source templates which are associated with the sources of record. The source of record manager allows the reference templates to be searched for and modified as needed. Once found, the reference templates may be used to access the data or information, or to build interfaces in an integrated application environment.

### BACKGROUND OF THE INVENTION

1. Field of the Invention

The present invention relates to approved or sanctioned sources of information, and more particularly, to a method and system for identifying and managing such approved or sanctioned sources of information.

2. History of the Related Art

Within a corporate or business environment, there can be many sources for the same and/or overlapping data or information. For instance, data regarding product inventory may be generated by both a company's purchasing department as well as its accounting department. The multiple sources of information can often result in confusion for internal and external users alike as to which information source is the correct one for corporate or business purposes.

One solution to the above problem involves the use of a “corporate dictionary,” sometimes also called a “data dictionary.” A corporate or data dictionary is a centralized database or repository that provides a convenient reference for finding approved sources of information. An approved information source is a source of information that has been sanctioned or otherwise designated as the official source for a particular type of information or data. Such an approved information source is commonly referred to as a “source of record” for that particular data The names and/or locations of the sources of record are thereafter listed in the corporate or data dictionary. Company or corporate personnel looking for a certain type of data or information can then access the corporate or data dictionary to quickly find the approved source for that information.

A drawback of the traditional corporate or data dictionary is that it merely lists the names and/or locations of the sources of record. There is no mechanism for easily accessing the data. Once the source of record is found, a certain amount of programming is still needed to make use of the information or data. For example, in an enterprise application environment, the source of the information or data must be interfaced with one or more applications that use the information or data. Thus, some programming is needed to extract, map, and transfer the information or data from the source to the destination applications. Moreover, in order to build the corporate or data dictionary, a company wide data model may need to be generated. The data model identifies the types of information or data that would be needed on a regular basis by the company. Finally, maintaining the corporate or data dictionary is typically a difficult and tedious task that requires additional resources and personnel.

Accordingly, it would be desirable to be able to provide an easier and more efficient way of storing and managing sources of record. More particularly, it would be desirable to be able to provide an efficient way of storing, managing, and retrieving the sources of record in a useful form.

### SUMMARY OF THE INVENTION

The present invention relates to a computer based method and system for storing, managing, and retrieving sources of record. The sources of record may be any source of information or data that has been sanctioned or otherwise designated as an approved source. Each information source has or may have one or more source templates associated therewith that describe or point to the information source and the information or data therein. A reference template may then be defined that describes or points to certain source templates or any subset thereof which are associated with the sources of record. Multiple reference templates may be associated with a single source template. The source of record manager allows the reference templates to be searched for and modified as needed. Once found, the reference templates may be used to build interfaces in an enterprise application environment.

In general, in one aspect, the invention is directed to a computer based method of managing sources of record. The method comprises retrieving a source template that describes a source of record. A reference template is then defined that describes the source template. The method further comprises storing the reference template, and assigning one or more selection criteria to the reference template. The reference template may then be searched for using the one or more selection criteria.

In general, in another aspect, the invention is directed to a computer system for managing sources of record. The system comprises a central processing unit, and a storage unit connected to the central processing unit. The storage unit stores computer readable instructions for causing the central processing unit to retrieve a source template that describes a source of record. A reference template is then defined that describes the source template. The computer readable instructions further cause the central processing unit to store the reference template, and assign one or more selection criteria to the reference template. The reference template may then be searched for using the one or more selection criteria.

In general, in still another aspect, the invention is directed to a computer based method of managing sources of record. The method comprises defining a reference template that describes the source of record. The method further comprises storing the reference template, and assigning one or more selection criteria to the reference template. The reference template may then be searched for using the one or more selection criteria.

In general, in yet another aspect, the invention is directed to a computer system for managing sources of record. The system comprises a central processing unit, and a storage unit connected to the central processing unit. The storage unit stores computer readable instructions for causing the central processing unit to define a reference template that describes the source of record. The computer readable instructions further cause the central processing unit to store the reference template, and assign one or more selection criteria to the reference template. The reference template may then be searched for using the one or more selection criteria.

### BRIEF DESCRIPTION OF THE DRAWINGS

A more complete understanding of the invention may be had by reference to the following detailed description when taken in conjunction with the accompanying drawings, wherein:

FIG. 1 is an overview of an integrated environment including a source of record manager system according to some embodiments of the invention;

FIG. 2 is a server for a source of record manager according to some embodiments of the invention;

FIG. 3 is a functional block diagram of a source of record manager according to some embodiments of the invention;

FIGS. 4A-C are screen shots of a graphical user interface according to some embodiments of the invention;

FIG. 5 is a functional block diagram of another source of record manager according to some embodiments of the invention;

FIG. 6 is another functional block diagram of a source of record manager according to some embodiments of the invention; and

FIG. 7 is a method of managing sources of record according to some embodiments of the invention.

### DETAILED DESCRIPTION OF THE INVENTION

Following is a detailed description of the invention wherein reference numerals designating the same and similar elements are carried forward throughout the various figures.

Embodiments of the invention provide a computer based source of record manager system and method. The source of record manager manages the information sources that have been designated as sources of record. More precisely, the source of record manager stores, manages, and retrieves one or more reference templates, or source of record manager (SPM) templates, that describe or point to either the actual sources of record, or to the source templates that in turn describe or point to the sources of record. The SPM templates themselves may then be used as source templates for building the interfaces between applications, databases, data processes, business processes, and the like. In some embodiments, the source of record manager uses existing source templates generated by an installed application integration system. In other embodiments, however, the source of record manager allows a user to manually generate the source templates as needed.

The information source may be any type of information source that is capable of providing any type of data or information. For example, the information source may include a spreadsheet, graph, chart, look-up table, text file, database, Web site, data linked library (dll), software program, Webservice, and the like. Other examples of information sources may include a business process, data process, conversion process, installation process, and the like. Further examples of information sources may include equations, conversion formulas, filters, rules, schedules, units of measure, and the like. Still further examples of information sources may include personnel such as a particular individual or a team. In some cases, the information source may include information regarding the destination applications that use the information or data contained in the information source. Accordingly, the use of the terms “information” and/or “data” are used throughout this description to include all of the above categories.

The source template, for purposes of this disclosure, may be any description or pointer to an information source and to the information or data contained therein. More specifically, the source template defines where the information or data resides and how it can be obtained. For example, the source template may include the name and location (e.g., the server, network, URL, building, site) of the source, and a description of the information or data (e.g., type, format). Where the information source is an individual or a group of individuals, the source template may describe or point to the HR (human resource) records for the individuals. In accordance with some embodiments of the invention, the source templates are in the form of metadata. Metadata is data that describes other data or information and may be stored in any data format such as XML (Extensible Markup Language) and similar data format standards.

In some embodiments, the source templates are created as part of an interface between various and often disparate applications, databases, data processes, business processes, and the like (hereinafter, “applications”). The interfaces integrate the various applications by defining and managing the transfer of information and data therebetween. The main components of the interfaces include the source template discussed above, a destination template that describes or points to the application or process which will receive the information or data, and a map that specifies how the information or data is to be transformed or otherwise converted between the source and destination applications.

The interfacing of the various applications and processes is often referred to as application integration, Enterprise Application Integration (EAI), and system integration. Integration systems essentially define and manage the flow of information and data to and from each application and/or process. An example of an integration system is Enterprise Enabler™ available from Stone Bond Technologies L.P., 1990 Post Oak Boulevard, Suite 900, Houston, Tex. 77056. Integration systems such as Enterprise Enabler™ are capable of performing a number of integration related tasks. These tasks include, for example, scheduling the transfer of data (e.g., based on some event or time period); validating the data (e.g., only use data for volumes of more than 50 gallons); applying one or more business rules (e.g, use Friday's data for Monday's process), formulas, or unit of measurement conversion to the data; processing the data using one or more data filters (which is a condition for accepting the data); and posting the data to a destination application.

More importantly, integration systems such as Enterprise Enabler™ facilitate the development of the interface components, including the source templates therein, that allow information and data to be exchanged between the various applications. Note that with an integration system like Enterprise Enabler™ in place, many of the source templates should already be available. However, in some instances, it may be desirable to create a new source template even with an integration system like Enterprise Enabler™ in place. Such an instance may occur, for example, when a brand new information source is designated as a source of record. Some integration systems do not create source templates that are useful to embodiments of the invention, and new source templates may also have to be created in these instances.

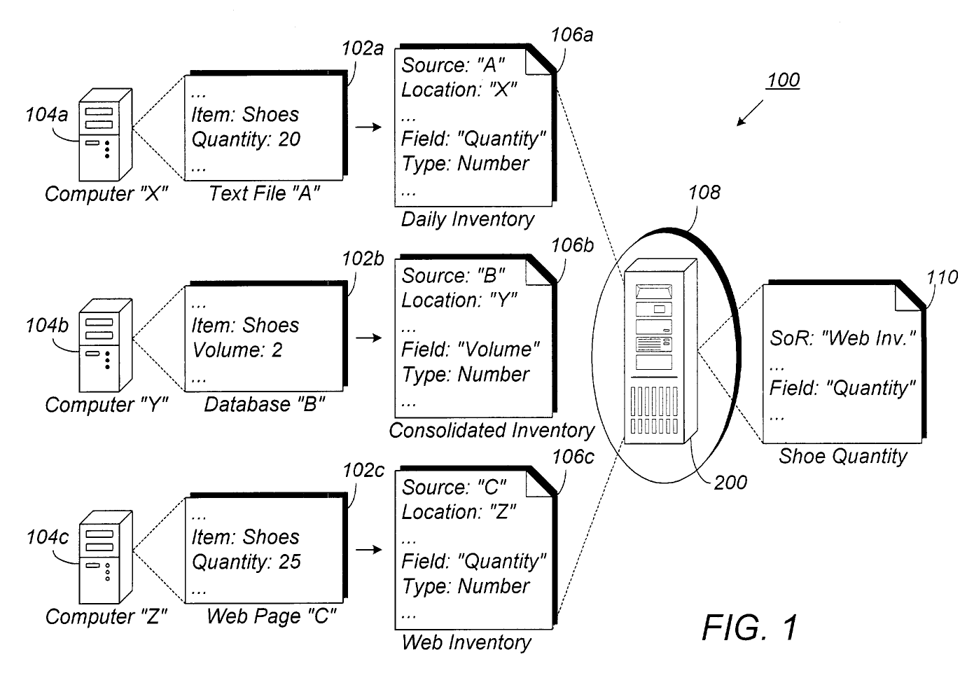

Referring now to FIG. 1, a portion of an integration system 100 is shown according to some embodiments of the invention. The integration system 100, upon implementation, incorporates the knowledge of a plurality of information sources 102a-c. As mentioned above, the information sources 102a-c may include any application, database, data process, business process, or the like, that is capable of generating or otherwise providing the desired information or data. The desired information or data may include any type of information or data including raw data, filtered data, business rules, conversion formulas, units of measurement, and other types of information or data. The information sources 102a-c reside on a plurality of computers 104a-c. For example, the first information source 102a (text file “A”) resides on computer “X” 104a (a file server); the second information source 102b (database “B”) resides on computer “Y” 104b (a database server); and the third information source 102c (Web page “C”) resides on computer “Z” 104c (a Web server).

Although three information sources 102a-c are shown here, it will be understood that the system may include fewer or more information sources as needed. In addition, it will be understood that the additional information sources may have the same data type and/or format as that described above, or they may have a different data type and/or format. Furthermore, several information sources 102a-c may reside on the same computer 104a-c, or each information source may reside on a separate computer, or there may be some combination of both. The computers 104a-c themselves may reside at the same physical location, or each computer may reside at a separate location, or there may be some combination of both.

In accordance with embodiments of the invention, the integration system 100 is an existing system and already includes a plurality of source templates 106a-c that have accumulated over time as new interfaces are created. Each source template 106a-c contains a metadata description of a respective one of the information sources 102a-c. For example, the source template 106a called “Daily Inventory” contains metadata that describes the name, location, one or more fields, and the data type for the fields in the first information source 102a, text file “A.” Similarly, the source template 106b called “Consolidated Inventory” contains metadata that describes the name, location, one or more fields, and the data type for the fields in the second information source 102b, database “B.” Likewise, the source template 106c called “Web Inventory” contains metadata that describes the name, location, one or more fields, and the data type for the fields in the third information source 102c, Web page “C.”

When an interface is created for a particular application, it is important to use a source template 106a-c corresponding to the correct information source 102a-c for the application. In many cases, several information sources 102a-c may include the same or overlapping information or data. For example, the first and third information sources 102a and 102c (text file “A” and web page “C”) both include information regarding the inventory of shoes. However, there is a discrepancy in the quantity field between the two information sources 102a and 102c. The second information source 102b (database “B”) has yet another value for the shoe quantity data, as well as a different field name for that data field, namely “Volume.” Accordingly, if an application needs to use data or information regarding shoe inventory, there may be some confusion as to which source template, and even which field, is the correct one to use.

In order to avoid the above confusion, a source of record manager system 108 is provided in accordance with embodiments of the invention. The source of record manager system 108 allows an authorized user to define an SRM template 110. The SRM template 110 contains a description or pointer to a certain one of the source templates 106a-c. The particular source template 106a-c described is the one corresponding to an information source 102a-c that has been designated as a source of record. The designation of the information source 102a-c as a source of record may occur coincident with the creation of the SRM template 110 (i.e., the designation is the creation of the SRM template). Alternatively, the designation of the information source 102a-c as a source of record may occur beforehand, and the SRM template 110 is created simply to make use of the information source 102a-c in an interface. The SRM templates 110 are then stored by the source of record manager system 108 in a centralized location. An authorized user may thereafter search for and modify the SRM template 110 as needed. Once found, the SRM templates 110 may be used in an integration system like Enterprise Enabler™ to quickly build interfaces between the various applications.

The SRM template 110, like the source templates 106a-c, contains a description or pointer that is in the form of metadata. However, the metadata in the SRM template 110 describes or points to the source template 106a-c, and not to the information sources 102a-c. In the example shown in FIG. 1, an authorized user has elected to make an SRM template 110 based on the “Web Inventory” source template 106c, and specifically the “Quantity” data field therein. Accordingly, the source of record manager system 108 has defined an SRM template 110 that contains a metadata description (or pointer) to the user's selection.

Because the source templates 106a-c often include much more information than may be of interest in defining the SRM templates 110, the granularity with which the SRM template 110 describes or points to a source template 106a-c may vary. For example, the SRM template 110 may describe or point to the entire source template 106a-c, or only certain elements (e.g., one or more data fields) within the source template 106a-c. In the latter case, the SRM template 110 also includes a description or pointer to the selected elements. Two or more SRM templates 110 may describe the same source template 106a-c, but with different granularities or subsets of data. For example, one SRM template may describe the entire source template, while another source template may describe only certain elements (e.g., data fields) in the same source template. Two or more SRM templates may also describe two or more different elements, identical elements, or overlapping sets of elements in the same source template Several SRM templates 110 may describe or point to the same source template 106a-c with the same granularity, but for different purposes (i.e., the SRM templates 110 will have different textural descriptions).

In some embodiments, the source of record manager system 108 includes one or more servers 200 that are capable of providing a large amount of data processing and storage capacity. The source templates 106a-c and the SRM templates 110 may be stored on the servers or high-end computers, although not necessarily on the same one. For convenience purposes, the source templates 106a-c and the SRM templates 110 are shown here as being stored on the same server 200.

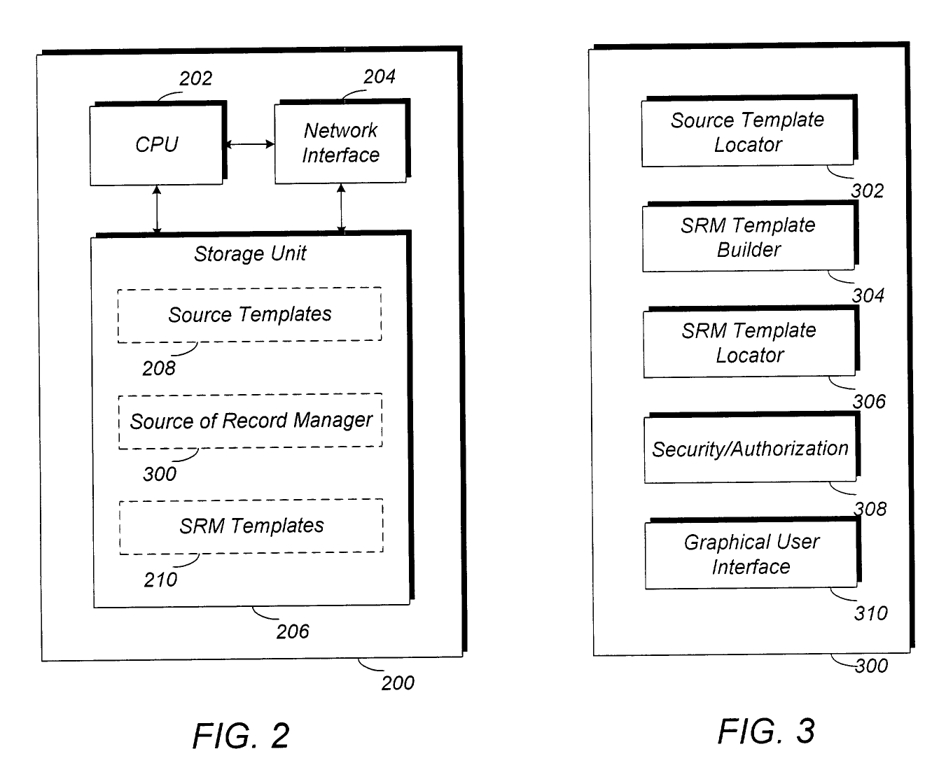

FIG. 2 illustrates a functional block diagram of a server 200 of the source of record manager system 108, according to some embodiments of the invention. As can be seen, the server 200 contains a number of components including a central processing unit 202, network access unit 204, and a storage unit 206. The central processing unit 202 may include one or more microprocessors, DSP, ASIC, or other data processing units, and is responsible for the overall operation of the server 200 including the execution of any software programs thereon. The network access unit 204 may include an Ethernet card or other network access cards, and provides the server 200 with access to a network. The storage unit 206 may include long-term data storage devices such as magnetic memory and optical memory, as well as short-term data storage devices such as random access memory (AM).

Stored within the storage unit 206 are software programs and data that are needed by the central processing unit to operate the server 200, including one or more source templates 106a-c and SRM templates 110. The source templates 106a-c exist, as mentioned above, by virtue of an integration system such as Enterprise Enabler™ being already in operation for some time. Thus, a number of interfaces have already been created along with the source templates that are used by the interfaces. The SRM templates 110 are generated by an authorized user and, in this embodiment, are based on the already existing source templates 106a-c. Such an arrangement takes advantage of the fact that an integration system like Enterprise Enabler™ has already created the source templates 106a-c used to build the SRM templates 110.

Also stored within the storage unit 206 is a source of record manager 300. In some embodiments, the source of record manager 300 is stored in the form of computer readable instructions that can be executed by the central processing unit 202. Such computer readable instructions may be derived or compiled from a language such as C++, Visual Basic, JAVA, Visual.net, C#, or other similar computer programming languages. The source of record manager 300 causes the central processing unit 202 to perform a number of tasks including retrieving a source template 106a-c that has been selected by an authorized user, defining an SRM template 110 for the source template 106a-c, and storing the SRM template 110 in the storage unit 206.

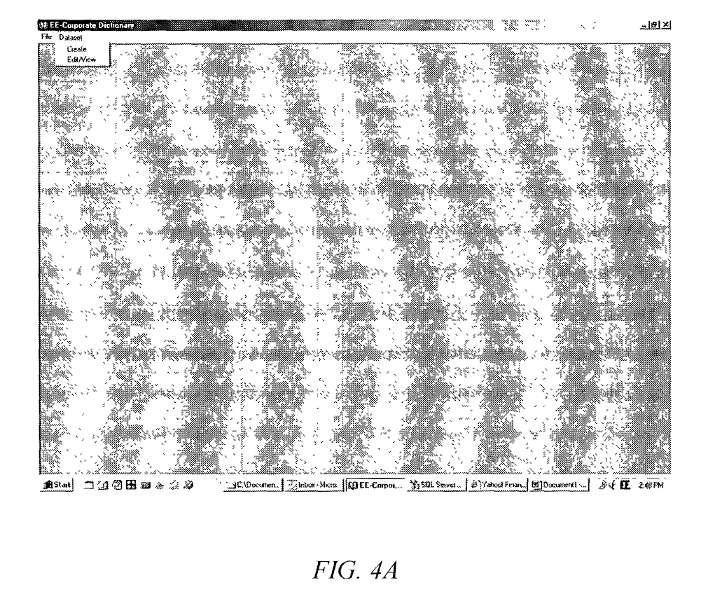

FIG. 3 illustrates a more detailed view of the source of record manager 300. As can be seen, the source of record manager 300 has a number of functional modules including a source template locator 302, an SRM template builder 304, an SRM template locator 306, a security/authorization module 308, and a graphical user interface 310. Although the functional modules are shown here as separate components, it will be understood that several modules may be combined into a single component, and that a single module may be divided into several sub-modules. Following is a description of each functional module.

The source template locator 302 is configured to find the source templates 106a-c that are available in an integration system such as Enterprise Enabler™. Specifically, the source template locator 302 performs a scan of the integration system and compiles a list of the source templates 106a-c available. The information included in the list may be any property or attribute information such as the name, category, application, or data type of the source templates 106a-c. The compiled list of source templates 106a-c is then incorporated into the source of record manager 300 and may subsequently be used to build SRM templates 110.

The SRM template builder 304 is configured to create or otherwise define an SRM template 110 based on the source template 106a-c selected by an authorized user. The source template 106a-c may be selected, for example, from the compiled list of source templates 106a-c mentioned above. For each selected source template 106a-c, one or more elements may also be selected. The authorized user may then specify a name for the SRM template 110 to be created. Preferably, the name is a meaningful name that is indicative of some aspect of the SRM template 110 (e.g., “Financial”). The SRM template builder 304 thereafter creates an SRM template 110 for the selected source template 106a-c. The SRM template 110 contains a metadata description or pointer to the selected source template 106a-c. The description or pointer may include, for example, the name of the source template 106a-c and the name of any data fields selected. In addition, the SRM template builder 304 also attaches any property or attribute information of the source template 106a-c to the SRM template 110.

In some embodiments, the SRM template builder 304 also allows the user to specify one or more dimensions for the SRM template 110. By way of explanation, dimensions are used in a data modeling technique called “dimensional modeling” to help describe the members of the data model. The dimension is usually a name that is descriptive of the members of the data model. Example of dimensions may be “Location,” “Product,” “Partners,” “Times,” or any other category that may be used by the data model. Each dimension may contain any number of values. Examples of the values contained in the “Location” dimension, for example, may be “Refinery 1,” “St. Louis,” or the like. Examples of the “Times” dimension may include fiscal year 2000, one month, a certain date, a certain time, and the like. However, it is not necessary that dimensional modeling actually be performed to implement the source of record manager 300 of the invention. The user simply picks or creates any dimension, and that dimension is created as a property or attribute of the SRM template 110. The dimensions may subsequently be used as search criteria to find or otherwise locate a specific SRM template 110 from among the available SRM templates 110.

The SRM template locator 306 is configured to allow an authorized user to search for a specific SRM template 110 from among the available SRM templates 110. Although any suitable searching technique may be used, in some embodiments, the SRM template locator 306 uses a dimensional searching technique. In dimensional searching, the user simply specifies a dimension, including a descriptive value therefor. The SRM template locator 306 thereafter returns a list of SRM templates 10 having a dimension and descriptive value that match the specified dimension and value.

In some embodiments, the SRM template locator 306 may use a Boolean search or other similar searches to locate a specific SRM template 110. The Boolean search may be performed using a keyword query that is based on the property and attribute information of the SRM template 110.

The security/authorization module 308 ensures that only authorized users may use the source of record manager 300. Thus, only those persons who have been granted authority to sanction or otherwise approve data can create SRM templates 110. In some embodiments, the security/authorization module 308 provides a number of security features including a unique identification and password for each user. The identification and password are issued by a system administrator or other authorized personnel who is responsible for setting up users.

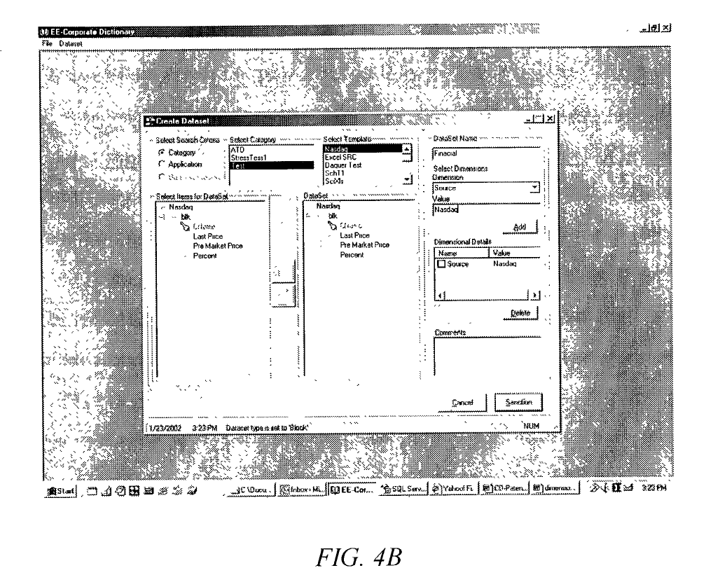

The graphical user interface 310 provides the source of record manager 300 with a user-friendly graphical interface. Such a graphical interface facilitates the interaction between the user and the source of record manager 300 so that even a relatively novice computer user may effectively operate the source of record manager 300. An example of such a graphical interface according to some embodiments of the invention is shown in FIGS. 4A-4C. It should be noted that the particular graphical interface shown in FIGS. 4A-4C are illustrative only, and that other graphical interfaces may be used without departing from the scope of the invention.

Referring to FIG. 4A, creation of a new SRM template 110 may be initiated by selecting the “Create” option under the “Dataset” menu item (where Dataset is used here as synonymous with SRM template). Alternatively, and existing SRM template 110 may be edited for modified by selecting the “Edit/View” option under the same menu item.

FIG. 4B shows the screen that appears if the “Create” option is selected, meaning that the user has chosen to create a new SRM template 110. Note that this screen may also be used to edit an existing SRM template 110. From the screen in FIG. 4B, the user can view a list of the available source templates 106a-c from which the SRM template 110 may be created. The user may elect to view the list of source templates 106a-c, for example, by “Category” or by “Application.” In the present example, the user has elected to view the list of source templates 106a-c by “Category,” and has chosen the “Test” category from among the available categories. From the list of available source templates 106a-c under this category, the user has selected a source template called “Nasdaq” to be used for the SRM template 110.

If the desired source template 106a-c does not exist (i.e., the information source of interest does not have a source template), the user may be directed to, or can choose to go to, a source template builder user interface. Such a source template builder user interface (not expressly shown) may be found, for example, in the Enterprise Enabler™ mentioned above. The user may then build a source template 106a-c for the desired information source.

Within the “Nasdaq” source template are a number of elements that may be selected including “CName,” “Last Price,” “Pre Market Price,” and “Percent.” Selection of the elements may be accomplished by clicking on the appropriate arrow buttons to transfer the elements from the source template 106a-c to the SRM template 110. Removal of the elements from the SRM template 110 may be accomplished in a similar manner. In the present example, the user has selected all of the elements in the “Nasdaq” source template.

At this point, the specific data that is the source of record has been identified, and the next step is to describe the data. Describing the data allows it to be found later with a high level of confidence that it is the correct data for a particular need. The user may then specify a name and one or more dimensions for the SRM template 110, including a value for each specified dimension. The user may also enter one or more detailed comments regarding the SRM template 110. The name, dimension, dimension value, and comments may subsequently be used to locate the SRM template 110. To create the SRM template 110, the user simply clicks on the “Sanction” button after all required information have been entered. Note that any number of SRM templates 110 may be created based on a single source template 106a-c.

FIG. 4C shows the screen that appears if the “Edit/View” option is selected under the “Dataset” menu item according to some embodiments of invention. In this screen, the user can search for an existing SRM template 110 by specifying or adding one or more dimensions and a value for each. Clicking the “Add” button returns a list of SRM templates 110 that match the specified dimension and value As more dimensions are added, the list of dimensions returned becomes smaller until one can be selected with more certainty. To edit one of the SRM templates 110, the user simply selects the desired SRM template 110, and clicks on the “Select” button. The same screen as in FIG. 4B appears, from which screen, the user may modify the SRM template 110 accordingly.

In the embodiments described above, the source of record manager 300 is able to take advantage of the fact that a number of source templates 106a-c already exist by virtue of an integration system such as Enterprise Enabler™. In this case, the source templates 106a-c do not have to be created (although they may be created through the integration system if the desired information source does not yet have a source template). Such an arrangement makes advantageous use of the already available resources and can speed up the process of developing a list of SRM templates 110 As a result, an authorized user can use an integration system such as Enterprise Enabler™ to quickly build new interfaces or modify existing interfaces using the SRM templates 110 as source templates. The use of an SRM template 110 as a source template in an interface ensures that the information and data employed by the applications within a company or corporation is accurate and consistent. Moreover, the time it takes to build an interface can be reduced, thereby accelerating the overall application integration process.

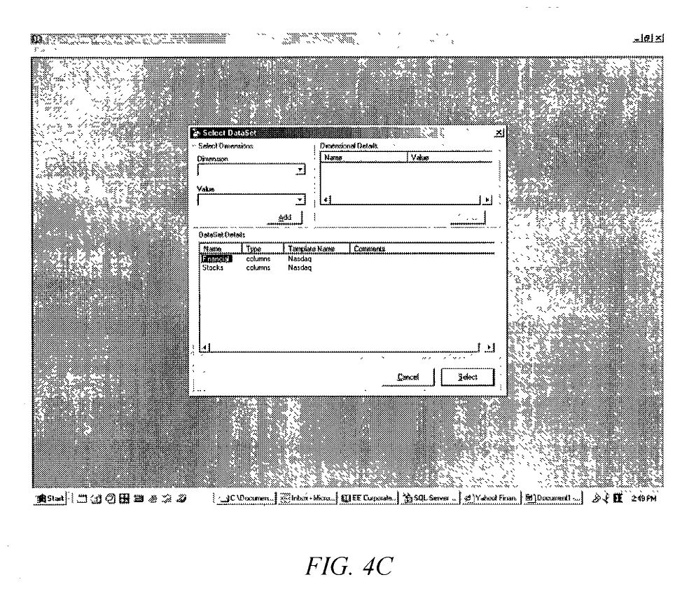

In some embodiments, however, an integration system may not exist or may only be recently installed and no source templates 106a-c are available. FIG. 5 illustrates a source of record manager 500 according to these embodiments. As can be seen, instead of (or in addition to) a source template locator 302, the source of record manager 500 includes a source template builder 502. The other functional modules of the source of record manager 500 are essentially the same as the functional modules of the source of record manager 300 of FIG. 3. Having the source template builder 502 allows an authorized user to manually enter information regarding a desired information source. The information entered by the authorized user may include the location of the information source, one or more elements (e.g., field names), and the data type and/or format of each elements. The source template builder 502 thereafter creates or defines a source template 106a-c based on the information provided by the authorized user. The source templates 106a-c may subsequently be used to create SRM templates 110 in the manner described above.

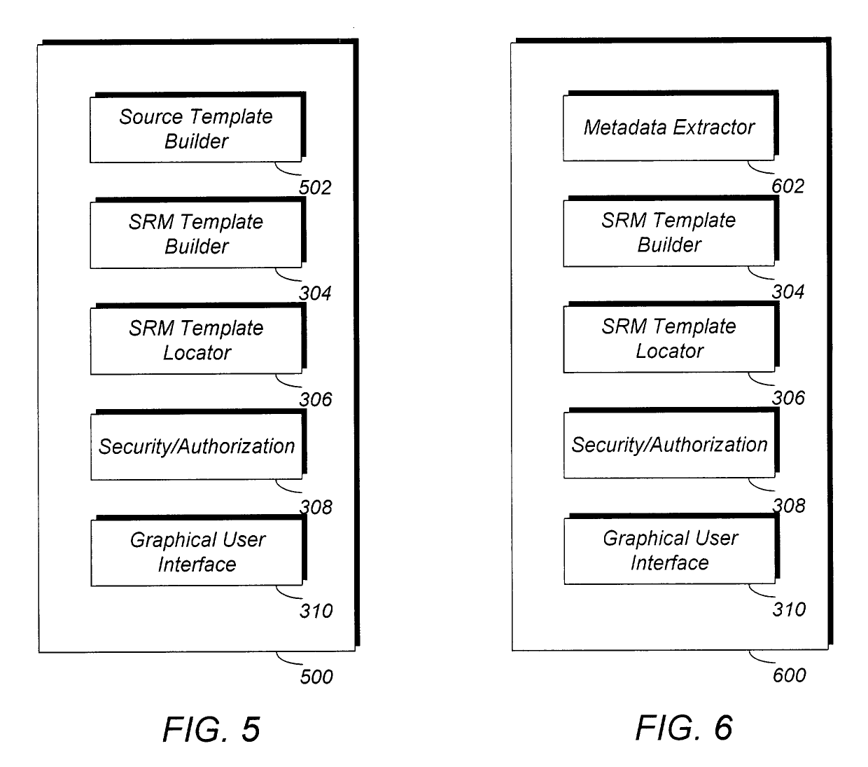

In some embodiments, the source templates 106a-c can be extracted from the data traffic (e.g., messages) in the integration system instead of being built from the information provided by the user. A source of record manager 600 according to these embodiments is shown in FIG. 6. The source of record manager 600 includes a metadata extractor 602 that is configured to monitor the flow of data in the integration system. Based on the data traffic in the integration system, the metadata extractor 602 determines which information sources should be designated as sources of record. The determination may be made based on one or more predetermined criteria such as the frequency with which the information source is accessed, or the number of applications and/or processes that are accessing the information source. Once the metadata extractor 602 identifies an information source to be designated as a source of record, the metadata extractor 602 extracts information regarding that information source from the integration system. The metadata extractor 602 thereafter creates a source template 106a-c for that information source based on the extracted information. The source template 106a-c may subsequently be used to create SRM templates 110 in the manner described above.

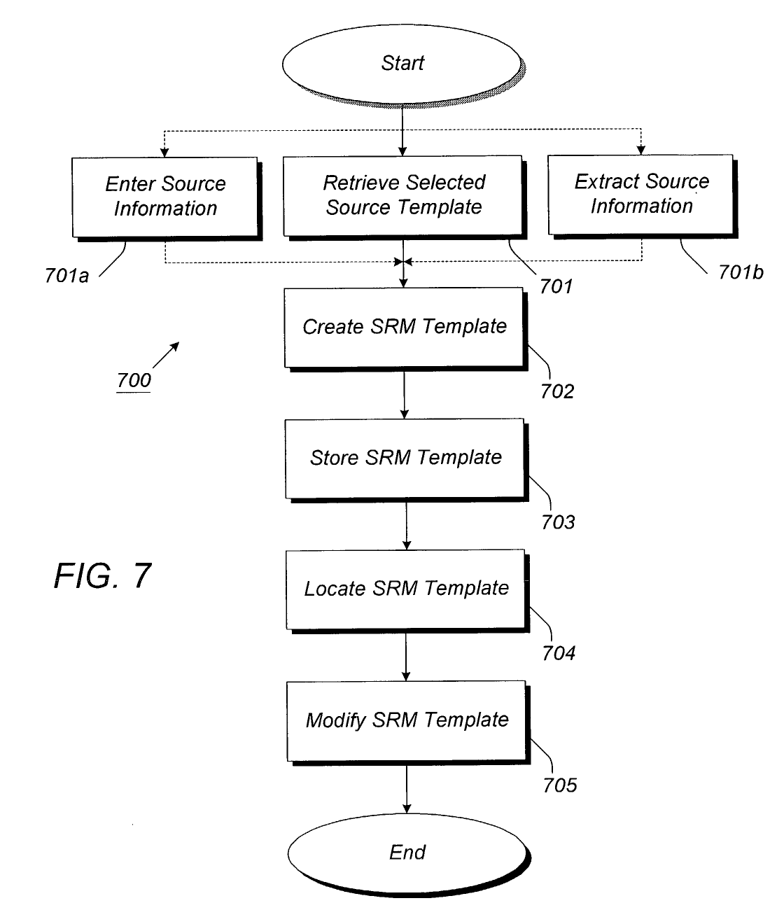

FIG. 7 illustrates a method of storing, managing, and retrieving SRM templates 110 according to some embodiments of the invention. The method 700 begins at step 701 where the source template 106a-c selected by an authorized user is retrieved. At step 702, an SRM template 110 identifying the selected source template 106a-c is created or otherwise defined. The SRM template 110 includes a description or pointer to the source template 106a-c (which, in turn, include a description or pointer to the information source 102a-c). Where specific elements in the source template 106a-c are selected, the SRM template 110 also includes a description or pointer to be selected elements At step 703, the SRM template 110 is stored, preferably in a centralized storage location for convenient access.

In some embodiments, at optional step 704, a search may be performed to locate a particular SRM template 110. The search may be performed based on a dimensional definition searching technique or any other suitable searching technique. At step 705, the particular SRM template 110 may be modified as needed.

In embodiments where there are no source templates 106a-c (either at all or for the desired information source), the method 700 may include an optional step 701a wherein the source templates 106a-c may be created from information regarding the information sources 102a-c entered by the user. (In that case, the user may be directed to, or may choose to go to, a source template builder user interface.) Alternatively, at optional step 701b, the information regarding the information source selected to be the basis for an SRM template 110 may be extracted from the data traffic observed in the system. Selection may be based upon one or more predetermined criteria such as frequency of access and number of applications or processes accessing the information source.

The invention has been described thus far as a two-tiered arrangement with SRM templates describing or pointing to source templates (or certain portions thereof). However, in some embodiments, the SRM templates may describe or point directly to the information sources instead of the source templates. In other words, the metadata in the SRM templates describe or point to the information sources themselves (or certain portions thereof), and not to the metadata in the source templates. The SRM templates in these embodiments may be created using an integration system such as Enterprise Enabler™ in a manner similar to the way the source templates are created. The difference is the SRM templates in these embodiments describe only information sources that are sources of record. As such, the SRM templates in these embodiments may be assigned one or more dimensions and values (described above) that may be used as search criteria to facilitate finding and locating the SRM templates later. Once found, the SRM templates in these embodiments may be used to build interfaces for an integration system in a manner similar to that described above.

As demonstrated by the foregoing, embodiments of the invention provide a system and method of managing sources of records. While a limited number of embodiments have been disclosed herein, those of ordinary skill in the art will recognize that variations and modifications from the described embodiments may be derived without departing from the scope of the invention. Accordingly, the appended claims are intended to cover all such variations and modifications as falling within the scope of the invention.

What is claimed is:

1. A computer based method of managing sources of record, comprising:
retrieving a source template, said source template describing a source of record;
defining a reference template for said source template, said reference template describing said source template;
storing said reference template;
assigning one or more selection criteria to said reference template, and
searching for said reference template using said one or more selection criteria.

2. The method according to claim 1, wherein said source template and/or said reference template are in the form of metadata.

3. The method according to claim 1, wherein said reference template further describes one or more elements of said source template.

4 The method according to claim 1, wherein said one or more selection criteria include one or more dimensional search criteria.

5. The method according to claim 4, further comprising searching for said reference template using said one or more dimensional search criteria.

6. The method according to claim 5, further comprising selecting said source template, one or more elements, and dimensional search criteria using one or more graphical user interfaces.

7. The method according to claim 1, wherein said reference template is defined independently of any information in said source template.

8. The method according to claim 1, wherein said source of record may be replaced with a different information source without modifying said reference template.

9. The method according to claim 1, wherein said source template is generated by an integration system, further comprising extracting said source template from said integration system.

10 The method according to claim 1, wherein said source template is generated by an authorized user using a manual entry process.

11. The method according to claim 1, wherein said source template is generated using information extracted from data traffic in an integration system.

12. The method according to claim 1, wherein said source of record may be any source of information including data, business rules, conversion formulas, units of measure, schedules, Webservices, XML standards, decisions made, names of individuals, and multimedia content.

13. The method according to claim 1, further comprising using said reference template in an application integration interface.

14. The method according to claim 1, further comprising accessing said reference template using an integration system.

15 The method according to claim 1, wherein multiple reference templates may be defined based on a single source template.

16 A computer system for managing sources of record, comprising:
a central processing unit; and
a storage unit connected to said central processing unit, said storage unit storing computer readable instructions for causing said central processing unit to
retrieve a source template, said source template describing a source of record;
define a reference template for said source template, said reference template describing said source template;
store said reference template;
assign one or more selection criteria to said reference template, and
search for said reference template using said one or more selection criteria.

17. The system according to claim 16, wherein said source template and said reference template are in the form of metadata.

18. The system according to claim 16, wherein said reference template further describes one or more elements of said source template.

19. The system according to claim 16, wherein said one or more selection criteria include one or more dimensional search criteria.

20. The system according to claim 19, wherein said computer readable instructions further cause said central processing unit to search for said reference template using said one or more dimensional search criteria.

21. The system according to claim 20, wherein said computer readable instructions further cause said central processing unit to implement one or more graphical user interfaces for selecting said source template, one or more elements, and dimensional search criteria.

22. The system according to claim 16, wherein said computer readable instructions cause said central processing unit to define said reference template independently of any information in said source template.

23. The system according to claim 16, wherein said source of record may be replaced with a different information source without modifying said reference template.

24. The system according to claim 16, wherein said source template is generated by an integration system, and said computer readable instructions further cause said central processing unit to extract said source template from said integration system.

25. The system according to claim 16, wherein said source template is generated by an authorized user using a manual entry process.

26. The system according to claim 16, wherein said computer readable instructions further cause said central processing unit to extract information for generating said source template from data traffic in an integration system.

27. The system according to claim 16, wherein said source of record may be any source of information including data, business rules, conversion formulas, units of measure, schedules, Webservices, XML standards, decisions made, names of individuals, and multimedia content.

28. The system according to claim 16, wherein said computer readable instructions further cause said central processing unit to use said reference template in an application integration interface.

29. The system according to claim 16, wherein said computer readable instructions further cause said central processing unit to access said reference template.

30 The method according to claim 16, wherein said computer readable instructions further cause said central processing unit to define multiple reference templates based on a single source template.

31. A computer based method of managing sources of record, comprising:
defining a reference template for said source of record, said reference template describing said source of record;
storing said reference template;
assigning one or more selection criteria to said reference template, and
searching for said reference template using said one or more selection criteria.

32 The method according to claim 31, wherein said reference template is in the form of metadata.

33 The method according to claim 31, wherein said reference template further describes a portion of said source of record.

34. The method according to claim 31, wherein said one or more selection criteria include one or more dimensional search criteria.

35 The method according to claim 34, further comprising searching for said reference template using said one or more dimensional search criteria.

36. The method according to claim 31, wherein said reference template is defined independently of any information in said source of record.

37 The method according to claim 31, wherein said source of record may be replaced with a different information source without modifying said reference template.

38. The method according to claim 31, wherein said source of record may be any source of information including data, business rules, conversion formulas, units of measure, schedules, Webservices, XML standards, decisions made, names of individuals, and multimedia content.

39. The method according to claim 31, further comprising using said reference template in an application integration interface.

40 The method according to claim 31, further comprising accessing said reference template using an integration system.

41. The method according to claim 31, wherein multiple reference templates may be defined based on a single source of record.

42. A computer system for managing sources of record, comprising:
a central processing unit; and
a storage unit connected to said central processing unit, said storage unit storing computer readable instructions for causing said central processing unit to:
define a reference template for said source of record, said reference template describing said source of record;
store said reference template;
assign one or more selection criteria to said reference template; and
search for said reference template using said one or more selection criteria.

43. The system according to claim 42, wherein said reference template is in the form of metadata.

44. The system according to claim 42, wherein said reference template further describes a portion of said source of record.

45 The system according to claim 42, wherein said one or more selection criteria include one or more dimensional search criteria.

46. The system according to claim 45, wherein said computer readable instructions further cause said central processing unit to search for said reference template using said one or more dimensional search criteria.

47. The system according to claim 42, wherein said computer readable instructions cause said central processing unit to define said reference template independently of any information in said source template.

48. The system according to claim 42, wherein said source of record may be replaced with a different information source without modifying said reference template.

49. The system according to claim 42, wherein said source of record may be any source of information including data, business rules, conversion formulas, units of measure, schedules, Webservices, XML standards, decisions made, names of individuals, and multimedia content.

50. The system according to claim 42, wherein said computer readable instructions further cause said central processing unit to use said reference template in an application integration interface.

51. The system according to claim 42, wherein said computer readable instructions further cause said central processing unit to access said reference template.

52. The method according to claim 42, wherein said computer readable instructions further cause said central processing unit to define multiple reference templates based on a single source template.
